(19) United States
(12) Patent Application Publication
(10) Pub. No.: US 2024/0372236 A1
(43) Pub. Date: Nov. 7, 2024

(54) WIDE-BANDWIDTH RADIO-FREQUENCY (RF) WINDOWS AND METHOD

(71) Applicant: Elve Inc., Davis, CA (US)

(72) Inventors: Mikhail Kuffel, Sacramento, CA (US); Danny Chan, San Mateo, CA (US); Michelle Gonzalez, Woodland, CA (US); Diana Gamzina Daugherty, Davis, CA (US); Richard Kowalczyk, Redwood City, CA (US)

(21) Appl. No.: 18/653,646

(22) Filed: May 2, 2024

Related U.S. Application Data
(60) Provisional application No. 63/464,596, filed on May 7, 2023.

(51) Int. Cl. H01P 1/08; H01P 3/127

(52) U.S. Cl. CPC H01P 1/08; H01P 3/127

(57) ABSTRACT

A radio-frequency (RF) window comprises a first flange assembly including a first flange having a first flange thickness between a first surface and a second surface, and a first waveguide channel; and a first window element having a first window thickness and disposed in the first waveguide channel at a first location; and a second flange assembly stacked against the first flange assembly, the second flange assembly including a second flange having a second flange thickness between a third surface and a fourth surface, and a second waveguide channel; and a second window element having a second window thickness and disposed in the second waveguide channel at a second location, such that when the first flange assembly is stacked against the second flange assembly the second window element has a predetermined distance to the first window element, the predetermined distance selected based on a desired frequency band of operations.

### CLAIM OF PRIORITY

This application claims benefit of U.S. Provisional Application Ser. No. 63/464,596, entitled “Mechanical Design of Wide Bandwidth RF Window,” filed May 7, 2023, which is incorporated by reference in its entirety herein for all purposes.

### TECHNICAL FIELD

This invention relates generally to radio frequency (RF) electronics, and more particularly provides wide-bandwidth radio-frequency (RF) window and methods.

### BACKGROUND

Radio-frequency (RF) windows (irises) are used to separate and transport an electromagnetic wave from one medium to another. For example, in vacuum electronic devices, RF windows are used to enclose a vacuum envelope on one side of the RF window and to allow transportation of the electromagnetic wave from inside of the vacuum envelope to different atmospheric conditions (e.g., outside/external) on the other side of the RF window. For an RF device (e.g., RF circuit) operating across a wide band of frequencies, the RF window needs to match or exceed the wide band of operations of the RF device. Unfortunately, RF windows commonly serve as a limiting factor for transmitting a wide band of frequencies.

### SUMMARY

Embodiments of the solution provide a wide-bandwidth radio-frequency (RF) window (iris), methods of manufacturing RF components for the wide-bandwidth RF window, and/or methods of assembling RF components to form the wide-bandwidth RF window. In some embodiments, the RF window comprises one or more flange assemblies, wherein each flange assembly includes a flange and one or more electromagnetic wave interface elements (one or more window elements) (e.g., one or more ceramic inserts) disposed inside of an opening in the flange. Each electromagnetic wave interface element may be made of ceramic and/or one or more other materials with low RF losses. In some embodiments, the flange may be made of metal and/or one or more other materials that allow for propagation and constraining of the electromagnetic wave.

RF performance of an RF window has been determined to be sensitive to the geometries (size, shape, orientation) and materials of the one or more electromagnetic wave interface elements in the waveguide channel. In embodiments having multiple electromagnetic wave interface elements in the waveguide channel, RF performance of the RF window has been determined to be sensitive to the positioning of the electromagnetic wave interface elements with respect to each other. Accordingly, by varying the geometries and/or materials of one or more of electromagnetic wave interface elements, the spacing between them, and their surrounding waveguide geometries, an RF window can be designed with a wide frequency band of operations coordinate with the operational needs of the RF device.

Some embodiments provide a simpler approach that reduces variables in designing and lowers precision demands in manufacturing a wide-bandwidth RF window with high quality RF performance. In some embodiments, each flange assembly may be designed to include a single electromagnetic wave interface element of the same or nearly the same size and shape as the waveguide. By generating the electromagnetic wave interface element of the same or nearly the same size and shape of the waveguide, the flange assembly generates a resonant mode at a certain frequency in the operating band of the waveguide. The size, shape and material properties of the electromagnetic wave interface element dictate the frequency and the quality factor of the resonant mode. By locating two electromagnetic wave interface elements with certain spacing therebetween, the RF window can be designed to provide a significantly wider bandwidth propagation mode. Accordingly, some embodiments may include two or more nearly identically sized (identically sized within design tolerances) precisely manufactured electromagnetic wave interface elements positioned in the waveguide channel with precise spacing away from each other to generate a desired band of operations for a given waveguide system.

To address the challenge of locating electromagnetic wave interface elements in the waveguide channel a precise distance away from each other, some embodiments use flanges formed to have precise thickness as well as electromagnetic wave interface elements formed to have precise thickness. In some embodiments, each of one or more electromagnetic wave interface elements may be positioned at one or more predetermined locations in the flange or inside one or more waveguides that are inserted in the flange. In some embodiments, standard WR-x type flange features may be manufactured (e.g., machined or etched) to have a desired size and thickness. The thickness of the flange can be controlled with extreme precision by lapping or grinding or starting with material sheet or plate stock rolled to precision.

In some embodiments, an electromagnetic wave interface element can be located or securely bonded to one end of the waveguide channel in the flange, flush with one of the flange surfaces, thereby providing a precise location mechanism for the electromagnetic wave interface element. Two or more nearly identical (identical within design tolerances) flange assemblies of this type can be stacked together. By designing the flange assemblies to have their surfaces tightly contact each other, the flange assemblies can be designed to generate precise spacing of the electromagnetic wave interface elements. As indicated above, the precise spacing may be calculated to provide an RF window with a desired band of operations for a given waveguide system. For an RF device (e.g., RF circuit) operating across a wide band of frequencies, the precise spacing may be calculated to provide the RF window that matches or exceeds the band of operations of the RF device.

In some embodiments, the electromagnetic wave interface elements may be ground to size and manufactured to be suitable for frequencies in microwave regions (3-30 GHz), in millimeter wave regions (30-300 GHz), in sub-terahertz regions (300 GHz-3 THz), and/or in terahertz regions (>3 THz). In some embodiments, each electromagnetic wave interface element can be inserted/bonded, grown, deposited or otherwise formed in the opening of the flange, or the flange can be formed around the electromagnetic wave interface elements. The RF window can be positioned between two waveguides, wherein each waveguide has a different atmospheric condition. In some embodiments, the electromagnetic wave interface elements may be disposed inside of the waveguide serving as an RF window to achieve proper bandwidth and RF losses while maintaining ultra-high vacuum on one side and other atmospheric conditions on the other side. The RF window can be used for applications in communications, radar, imaging, bio-chemistry, and other applications where access to instantaneous or sweeping bandwidth of frequencies is desired.

Alignment of the flange assemblies and/or other components such as external waveguides may be achieved using alignment features, such as pins or other clocking features in the flange itself, which may be configured to result in precise alignment of the electromagnetic wave interface elements.

According to some embodiments, the present invention provides a radio-frequency (RF) window, comprising a flange having a flange thickness and including a waveguide channel; and a window element having dimensions based on the waveguide channel and having a window thickness based on a desired resonant operation, the window element disposed in the waveguide channel at a first location.

The flange may be made of metal and the window element may be made of ceramic. The RF window may be used to separate different environments on both sides of the RF window. The waveguide channel may be a rectangular waveguide, rectangular waveguide with round corners, circular waveguide, elliptical waveguide, overmoded waveguide, ridged waveguide, or corrugated waveguide. The RF window may be configured for use with a passive waveguide. The RF window may be configured for use at microwave frequencies (3-30 GHz), millimeter wave frequencies (30-300 GHz), sub-THz frequencies (300 GHz-3 THz), or THz frequencies (>3 THz).

According to some embodiments, the present invention provides a radio-frequency (RF) window, comprising a flange including a first flange surface, a second flange surface, a flange thickness between the first flange surface and the second flange surface, and a waveguide channel; and a first window element disposed in the waveguide channel at a first location; and a second window element disposed in the waveguide channel at a second location, the first window element and the second window element being separated by a predetermined distance based on a desired frequency band of operations.

At least one of the first and second window elements may be made of ceramic. The first window element may be positioned with a first window surface flush with the first flange surface. The second window element may be positioned with a second window surface flush with the second flange surface. The first window element may be positioned with a first window surface recessed within the waveguide channel. The first window element may be disposed with a first window surface protruding from the first flange surface. The RF window may be used to separate different environments on both side of the RF window.

According to some embodiments, the present invention provides a flange assembly, comprising a flange having a first flange surface, a second flange surface, a flange thickness between the first flange surface and the second flange surface, and a waveguide channel; and a window element having a window thickness and disposed in the waveguide channel at a predetermined location, such that when the window element is positioned at the predetermined location the window element has a first distance to the first flange surface and a second flange distance to the second surface, at least one of the first distance or the second distance selected based on a desired frequency band of operations.

The flange may be made of metal and the window element may be made of ceramic. The flange assembly may be configured to be stacked against a second flange assembly. The flange assembly may be configured to be stacked with a nearly identical second flange assembly. The first distance may be zero and the second distance may be not zero. The first distance may be zero and the second distance may be zero.

According to some embodiments, the present invention provides a radio-frequency (RF) window, comprising a first flange assembly including a first flange having a first flange surface, a second flange surface, a first flange thickness between the first flange surface and the second flange surface, and a first waveguide channel; and a first window element having a first window thickness and disposed in the first waveguide channel at a first location; and a second flange assembly stacked against the first flange assembly, the second flange assembly including a second flange having a third flange surface, a fourth flange surface, a second flange thickness between the third flange surface and the fourth flange surface, and a second waveguide channel; and a second window element having a second window thickness and disposed in the second waveguide channel at a second location, such that when the first flange assembly is stacked against the second flange assembly the second window element has a predetermined distance to the first window element, the predetermined distance selected based on a desired frequency band of operations.

The first flange assembly may be nearly identical to the second flange assembly. The first flange thickness may be nearly identical to the second flange thickness. The first window thickness may be nearly identical to the second window thickness. Each of the first window element and the second window element may be made of ceramic. The first window element may be positioned into a waveguide component and waveguide component may be positioned in the first waveguide channel. The first window element may be positioned with a first window surface flush with the first flange surface. The second window element may be positioned with a second window surface flush with the second flange surface. The waveguide channel space between the first window element and the second window element may form a resonant cavity, and geometry of the resonant cavity may be based on a desired frequency band of operations. The RF window may be used to separate different environments on both sides of the RF window.

### BRIEF DESCRIPTION OF THE DRAWINGS

FIG. 1 is a cross-sectional exploded side view of a radio-frequency (RF) waveguide system with an RF window, in accordance with some embodiments of the present invention.

FIG. 2 is a cross-sectional side view of the RF window of FIG. 1 when the flange assemblies of FIG. 1 are tightly positioned against each other, in accordance with some embodiments of the present invention.

FIG. 3 is a front view of a flange of FIG. 2, in accordance with some embodiments of the present invention.

FIG. 4 is a cross-sectional side view of an RF window having a single flange assembly, in accordance with some embodiments of the present invention.

FIG. 5 is a flowchart illustrating a method of forming a flange, in accordance with some embodiments of the present invention.

FIG. 6 is a flowchart illustrating a method of assembling an RF window using a single flange assembly, in accordance with some embodiments of the present invention.

FIG. 7 is a flowchart illustrating a method of assembling an RF window using multiple flange assemblies, in accordance with some embodiments of the present invention.

FIG. 8A is a cross-sectional side view of an electromagnetic wave interface element in a waveguide, in accordance with some embodiments of the present invention.

FIG. 8B is a graph of a transmission/reflection coefficient relative to frequency for the electromagnetic wave interface element of FIG. 8A, in accordance with some embodiments of the present invention.

FIG. 9A is a cross-sectional side view of first and second identical electromagnetic wave interface elements in a waveguide, in accordance with some embodiments of the present invention.

FIG. 9B is a graph of a transmission/reflection coefficient relative to frequency for the first electromagnetic wave interface element of FIG. 9A, in accordance with some embodiments of the present invention.

FIG. 9C is a graph of a transmission/reflection coefficient relative to frequency for the second electromagnetic wave interface element of FIG. 9A, in accordance with some embodiments of the present invention.

FIG. 9D is a graph of a transmission/reflection coefficient relative to frequency for the first electromagnetic wave interface element of FIG. 9A, in accordance with some embodiments of the present invention.

FIG. 9E is a graph of a transmission/reflection coefficient relative to frequency for the second electromagnetic wave interface element of FIG. 9A, in accordance with some embodiments of the present invention.

FIG. 9F a cross-sectional side view of the first and second identical electromagnetic wave interface elements spaced apart by distance L in the waveguide of FIG. 9A and further illustrating transmission and reflection paths of an electromagnetic wave at frequency f1, in accordance with some embodiments of the present invention.

FIG. 9G is a graph of a transmission/reflection coefficient relative to frequency for the combination of the first and second electromagnetic wave interface elements of FIG. 9F, in accordance with some embodiments of the present invention.

FIG. 10 is a graph of a series of transmission reflection coefficients relative to frequency for the combination of the first and second electromagnetic wave interface elements of FIG. 9F by varying the spacing L between them, in accordance with some embodiments of the present invention.

### DETAILED DESCRIPTION

The following description is provided to enable a person skilled in the art to make and use various embodiments of the invention. Modifications are possible. The generic principles defined herein may be applied to the disclosed and other embodiments without departing from the spirit and scope of the invention. Thus, the claims are not intended to be limited to the embodiments disclosed, but are to be accorded the widest scope consistent with the principles, features and teachings herein.

Embodiments of the solution provide a wide-bandwidth radio-frequency (RF) window (iris), methods of manufacturing RF components for the wide-bandwidth RF window, and/or methods of assembling RF components to form the wide-bandwidth RF window. In some embodiments, the RF window comprises one or more flange assemblies, wherein each flange assembly includes a flange and one or more electromagnetic wave interface elements (one or more window elements) (e.g., one or more ceramic inserts) disposed inside of an opening in the flange. Each electromagnetic wave interface element may be made of ceramic and/or one or more other materials with low RF losses. In some embodiments, the flange may be made of metal and/or one or more other materials that allow for propagation and constraining of the electromagnetic wave.

RF performance of an RF window has been determined to be sensitive to the geometries (size, shape, orientation) and materials of the one or more electromagnetic wave interface elements in the waveguide channel. In embodiments having multiple electromagnetic wave interface elements in the waveguide channel, RF performance of the RF window has been determined to be sensitive to the positioning of the electromagnetic wave interface elements with respect to each other. Accordingly, by varying the geometries and/or materials of one or more of electromagnetic wave interface elements, the spacing between them, and their surrounding waveguide geometries, an RF window can be designed with a wide frequency band of operations coordinate with the operational needs of the RF device.

Some embodiments provide a simpler approach that reduces variables in designing and lowers precision demands in manufacturing a wide-bandwidth RF window with high quality RF performance. In some embodiments, each flange assembly may be designed to include a single electromagnetic wave interface element of the same or nearly the same size and shape as the waveguide. By generating the electromagnetic wave interface element of the same or nearly the same size and shape of the waveguide, the flange assembly generates a resonant mode at a certain frequency in the operating band of the waveguide. The size, shape and material properties of the electromagnetic wave interface element dictate the frequency and the quality factor of the resonant mode. By locating two electromagnetic wave interface elements with certain spacing therebetween, the RF window can be designed to provide a significantly wider bandwidth propagation mode. Accordingly, some embodiments may include two or more nearly identically sized (identically sized within design tolerances) precisely manufactured electromagnetic wave interface elements positioned in the waveguide channel with precise spacing away from each other to generate a desired band of operations for a given waveguide system.

To address the challenge of locating electromagnetic wave interface elements in the waveguide channel a precise distance away from each other, some embodiments use flanges formed to have precise thickness as well as electromagnetic wave interface elements formed to have precise thickness. In some embodiments, each of one or more electromagnetic wave interface elements may be positioned at one or more predetermined locations in the flange or inside one or more waveguides that are inserted in the flange. In some embodiments, standard WR-x type flange features may be manufactured (e.g., machined or etched) to have a desired size and thickness. The thickness of the flange can be controlled with extreme precision by lapping or grinding or starting with material sheet or plate stock rolled to precision.

In some embodiments, an electromagnetic wave interface element can be located or securely bonded to one end of the waveguide channel in the flange, flush with one of the flange surfaces, thereby providing a precise location mechanism for the electromagnetic wave interface element. Two or more nearly identical (identical within design tolerances) flange assemblies of this type can be stacked together. By designing the flange assemblies to have their surfaces tightly contact each other, the flange assemblies can be designed to generate precise spacing of the electromagnetic wave interface elements. As indicated above, the precise spacing may be calculated to provide an RF window with a desired band of operations for a given waveguide system. For an RF device (e.g., RF circuit) operating across a wide band of frequencies, the precise spacing may be calculated to provide the RF window that matches or exceeds the band of operations of the RF device.

In some embodiments, the electromagnetic wave interface elements may be ground to size and manufactured to be suitable for frequencies in microwave regions (3-30 GHz), in millimeter wave regions (30-300 GHz), in sub-terahertz regions (300 GHz-3 THz), and/or in terahertz regions (>3 THz). In some embodiments, each electromagnetic wave interface element can be inserted/bonded, grown, deposited or otherwise formed in the opening of the flange, or the flange can be formed around the electromagnetic wave interface elements. The RF window can be positioned between two waveguides, wherein each waveguide has a different atmospheric condition. In some embodiments, the electromagnetic wave interface elements may be disposed inside of the waveguide serving as an RF window to achieve proper bandwidth and RF losses while maintaining ultra-high vacuum on one side and other atmospheric conditions on the other side. The RF window can be used for applications in communications, radar, imaging, bio-chemistry, and other applications where access to instantaneous or sweeping bandwidth of frequencies is desired.

Alignment of the flange assemblies and/or other components such as external waveguides may be achieved using alignment features, such as pins or other clocking features in the flange itself, which may be configured to result in precise alignment of the electromagnetic wave interface elements.

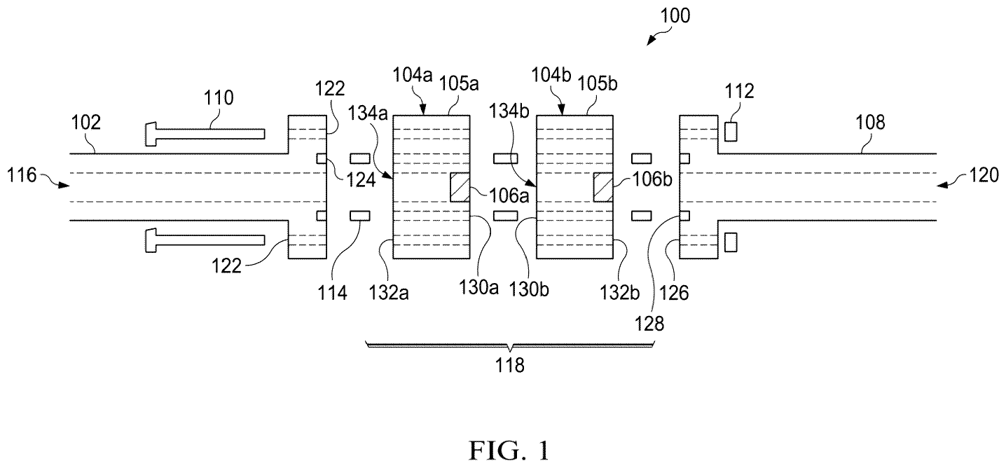

FIG. 1 is a cross-sectional exploded side view of a passive or active radio-frequency (RF) waveguide system 100, in accordance with some embodiments of the present invention. The RF waveguide system 100 includes a left waveguide 102 coupled via an RF window 118 to a right waveguide 108. The left waveguide 102 includes a left waveguide channel 116, left attachment channels 122 and left alignment channels 124. The right waveguide 108 includes a right waveguide channel 120, right attachment channels 126 and right alignment channels 128. The RF window 118 includes a first flange assembly 104a and a second flange assembly 104b. The first flange assembly 104a includes a first flange 105a having a first waveguide channel 134a, first attachment channels 132a and first alignment channels 130a. The second flange assembly 104b includes a second flange 105b having a second waveguide channel 134b, second attachment channels 132b and second alignment channels 130b. Alignment pins 114 may be inserted between the left alignment channels 124 and the first alignment channels 130a, between the first alignment channels 130a and the second alignment channels 130b, and between the second alignment channels 130b and the right alignment channels 128 to align the components and their features, including the left waveguide channel 116, the first waveguide channel 134a, the second waveguide channel 134b, and the right waveguide channel 120, with each other. After establishing proper alignment, screws 110 may be inserted across the left attachment channels 122, the first attachment channels 132a, the second attachment channels 132b, and the right attachment channels 126 and tightened using bolts 112 to secure the components together. Other alignment mechanisms or attachment mechanisms may additionally or alternatively be used. In some embodiments, the attachment mechanism and the alignment mechanism may be the same mechanism.

The first flange assembly 104a may include a first electromagnetic wave interface element 106a (which may be or include a first ceramic insert) positioned on the right side of the first waveguide channel 134a, such that the right surface of the first electromagnetic wave interface element 106a is flush with the right surface of the first flange 105a. Although shown as positioned flush with the right surface of the first flange 105a, the first electromagnetic wave interface element 106a may be positioned in a different location, such as flush with the left surface of the first flange 105a or at an inner position in the first waveguide channel 134a (with predesigned distances to the left and/or right surfaces of the first flange 105a). To assist with positioning the first electromagnetic wave interface element 106a at a position located within the first waveguide channel 134a, the first waveguide channel 134a may include first alignment features, such as one or more fixed protrusions or protrusions created by one or more alignment pins that may be removed or partially withdrawn after positioning and bonding of the first electromagnetic wave interface element 106a.

The second flange assembly 104b may include a second electromagnetic wave interface element 106b (which may be or include a second ceramic insert) positioned on the right side of the second waveguide channel 134b, such that the right surface of the second electromagnetic wave interface element 106b is flush with the right surface of the second flange 105b. Although shown as positioned flush with the right surface of the second flange 105b, the second electromagnetic wave interface element 106b may be positioned in a different location, such as flush with the left surface of the second flange 105b or at an inner position in the second waveguide channel 134b (with predesigned distances to the left and/or right surfaces of the second flange 105b). To assist with positioning the second electromagnetic wave interface element 106b at a position located within the second waveguide channel 134b, the second waveguide channel 134b may include second alignment features, such as one or more fixed protrusions or protrusions created by alignment pins that may be removed or partially withdrawn after positioning and bonding of the second electromagnetic wave interface element 106b. In some embodiments, the second flange assembly 104b may be nearly identical (identical within design tolerances) to the first flange assembly 104a.

The sizes and shapes of the left waveguide channel 116, the first waveguide channel 132a, the second waveguide channel 132b and the right waveguide channel 120 may be the same or may vary, depending on the design and desired RF performance. The geometries of the first electromagnetic wave interface element 106a and the second electromagnetic wave interface element 106b may be the same or may vary, depending on the design and desired RF performance. The distance between the first electromagnetic wave interface element 106a and the second electromagnetic wave interface element 106b may depend on the design and desired RF performance. Although the first flange assembly 104a and the second flange assembly 104b are shown as nearly identical, they need not be. For example, the first flange assembly 104a may be thinner, which as long as the first electromagnetic wave interface element 106a remains on the right surface may not affect the spacing between the first electromagnetic wave interface element 106a and the second electromagnetic wave interface element 106b. Further, the materials used for the first electromagnetic wave interface element 106a and the second electromagnetic wave interface element 106b may be the same or may vary, depending on the design and desired RF performance. Although shown as an integral structure, the flange 105a and/or the flange 105b may be formed from multiple sections affixed together.

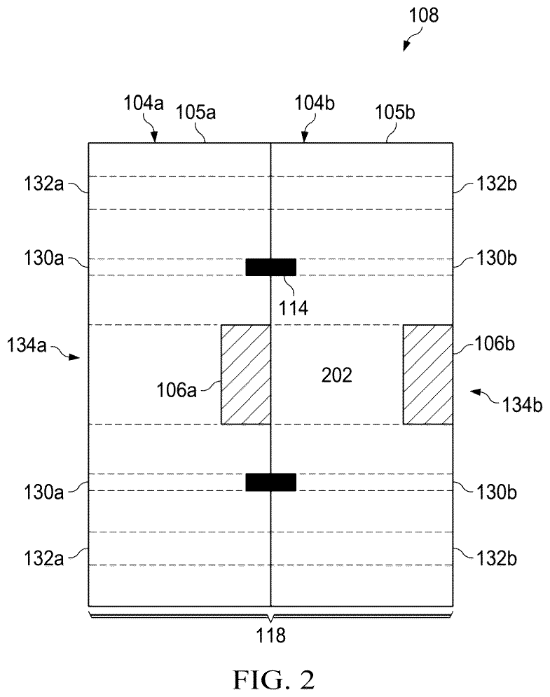

FIG. 2 is a cross-sectional side view of the RF window 118, in accordance with some embodiments of the present invention. The RF window 118 includes the first flange assembly 104a and the second flange assembly 104b with the right surface of the first flange assembly 104a tightly positioned against the left surface of the second flange assembly 104b. The first flange assembly 104a includes the first waveguide channel 134a, first attachment channels 132a and first alignment channels 130a. The second flange assembly 104b includes the second waveguide channel 134b, second attachment channels 132b and second alignment channels 130b. Alignment pins 114 may have been inserted between the first alignment channels 130a and the second alignment channels 130b to align the components and their features, including the first waveguide channel 134a and the second waveguide channel 134b with each other.

As shown, because the first flange assembly 104a includes the first electromagnetic wave interface element 106a designed with precise dimensions and positioned on the right side of the first waveguide channel 134a, such that the right surface of the first electromagnetic wave interface element 106a is flush with the right surface of the first flange assembly 104a, and because the second flange assembly 104b includes the second electromagnetic wave interface element 106b designed with precise dimensions and positioned on the right side of the second waveguide channel 134b, such that the right surface of the second electromagnetic wave interface element 106b is flush with the right surface of the second flange assembly 104b, a resonant cavity 202 with precise dimensions may be generated between the first electromagnetic wave interface element 106a and the second electromagnetic wave interface element 106b after stacking them. In some embodiments, RF performance of the RF window 118 may be based on the geometry of the resonant cavity 202 or primarily the distance between the first electromagnetic wave interface element 106a and the second electromagnetic wave interface element 106b.

As indicated above, although shown as positioned flush with the right surface of the first flange 105a, the first electromagnetic wave interface element 106a may be positioned in a different location, such as flush with the left surface of the first flange 105a, at an inner position in the first waveguide channel 134a or protruding from either side. Further, as indicated above, although shown as positioned flush with the right surface of the second flange 104, the second electromagnetic wave interface element 106b may be positioned in a different location, such as flush with the left surface of the second flange 104, at an inner position in the second waveguide channel 134b or protruding from either side. It will be noted that the same geometry of the resonant cavity 202 may be achieved with the first electromagnetic wave interface element 106a and the second electromagnetic wave interface element 106b each placed at a different position in their respective waveguide channels of their respective flanges 104a and 104b. Further, the geometries of the first electromagnetic wave interface element 106a and/or the second electromagnetic wave interface element 106b may be different, and form the resonant cavity 202 with the same or different geometry. Still further, the same resonant cavity can be formed using the first electromagnetic wave interface element 106a and the second electromagnetic wave interface element 106b each placed at a different position in a single flange.

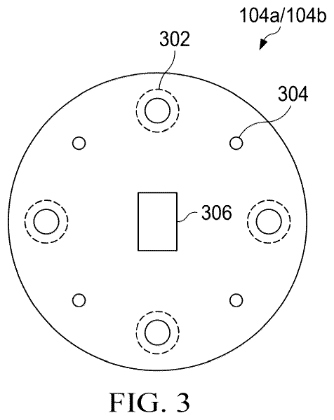

FIG. 3 is a front view of the first flange assembly 104a or the second flange assembly 104b of the RF window 118, in accordance with some embodiments of the present invention. The first flange assembly 104a or the second flange assembly 104b includes a round face having four attachment channel openings 302 to four attachment channels 132a/132b, four alignment channel openings 304 to four alignment channels 130a/130b, and a first waveguide opening 306 to the first waveguide channel 132a/132b. As shown, the each waveguide 134a or 134b is shown as rectangular, other waveguide types are possible, such as round, square, rectangular with round corners, elliptical, ridged, overmoded, and corrugated.

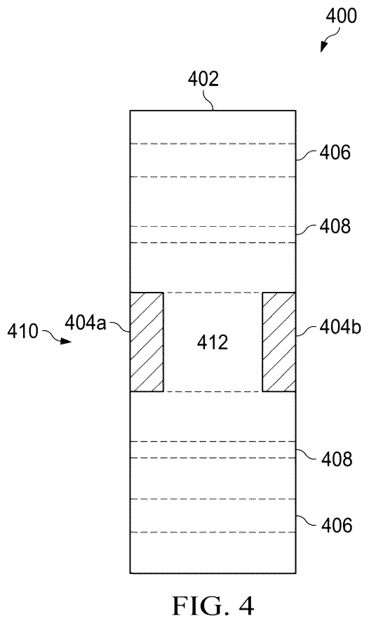

FIG. 4 is a cross-sectional side view of an RF window 400 having a single flange assembly, in accordance with some embodiments of the present invention. The RF window 400 includes a flange 402 and two electromagnetic wave interface elements 404a and 404b inside the waveguide channel 410. As shown and described above, the flange 402 may include attachment channels 406 and alignment channels 408.

In some embodiments, the first electromagnetic wave interface element 404a may be designed with precise dimensions and positioned on the left side of the waveguide channel 410 such that its left surface is flush with the left surface of the flange 402. Similarly, in some embodiments, the second electromagnetic wave interface element 404b may be designed with precise dimensions and positioned on the right side of the waveguide channel 410 such that its right surface is flush with the right surface of the flange 402. That way, based on the thickness of the flange 402 and the thicknesses of the two electromagnetic wave interface elements 404a and 404b, the two electromagnetic wave interface elements 404a and 404b can be precisely spaced apart to form a resonant cavity 412 with precise dimensions.

As indicated above, although shown as positioned flush with the left surface of the flange 402, the first electromagnetic wave interface element 404a may be positioned in a different location, such as at a left inner position in the waveguide channel 410 or protruding therefrom. Similarly, although shown as positioned flush with the right surface of the flange 402, the second electromagnetic wave interface element 404b may be positioned in a different location, such as at a right inner position in the waveguide channel 410 or protruding therefrom. It will be noted that the same geometry of the resonant cavity 412 may be achieved with the first electromagnetic wave interface element 404a and the second electromagnetic wave interface element 404b each placed at a different position in the waveguide channel 410. Further, the geometries of the first electromagnetic wave interface element 404a and/or the second electromagnetic wave interface element 404b may differ, and form the resonant cavity 412 with the same or different geometry.

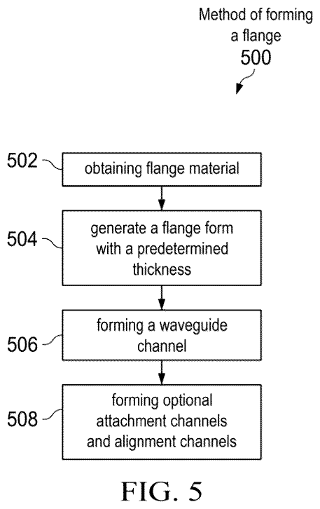

FIG. 5 is a flowchart illustrating a method 500 of forming a flange, e.g., flange 105a, 105b or 402, in accordance with some embodiments of the present invention. Method 500 begins in step 502 with the step of obtaining flange material, e.g., a metal and/or other material that allows for propagation and constraining of the electromagnetic wave. In step 504, a form having a predetermined thickness is generated from the flange material. In step 506, a waveguide channel, e.g., waveguide channel 134a, 134b or 410 is generated in the form. In step 508, optional attachment channels, e.g., attachment channels 132a, 132b or 406, and/or optional alignment channels, e.g., alignment channels 130a, 130b or 408, may be generated in the form.

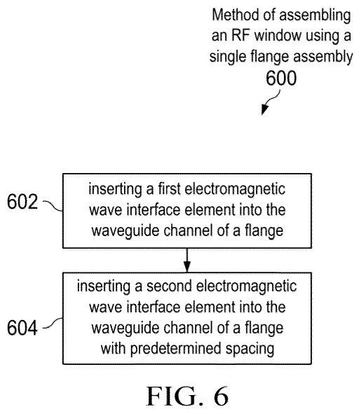

FIG. 6 is a flowchart illustrating a method 600 of assembling an RF window, e.g., RF window 400, using a single flange, e.g., flange 402, in accordance with some embodiments of the present invention. Method 600 begins in step 602 with a first electromagnetic wave interface element, e.g., first electromagnetic wave interface element 404a, being inserted into the waveguide channel, e.g., the waveguide channel 410. In some embodiments, the first electromagnetic wave interface element may be positioned on the left side of the waveguide channel. Although shown as positioned flush with the left surface of the flange, the first electromagnetic wave interface element may be positioned at a different location, such as at an inner position in the waveguide channel or protruding therefrom. In step 604, a second electromagnetic wave interface element, e.g., second electromagnetic wave interface element 404b, is inserted into the waveguide channel, e.g., the waveguide channel 410, at a predetermined spacing from the first electromagnetic wave interface element. In some embodiments, the second electromagnetic wave interface element may be positioned on the right side of the waveguide channel. Although shown as positioned flush with the right surface of the flange, the second electromagnetic wave interface element may be positioned at a different location, such as at an inner position in the waveguide channel or protruding therefrom. In some embodiments, the pair of electromagnetic wave interface elements form a resonant cavity therebetween. To achieve a particular spacing of the first electromagnetic wave interface element and the second electromagnetic wave interface element, each of the flange, the first electromagnetic wave interface element and the second electromagnetic wave interface element may be formed with precise dimensions (including thickness).

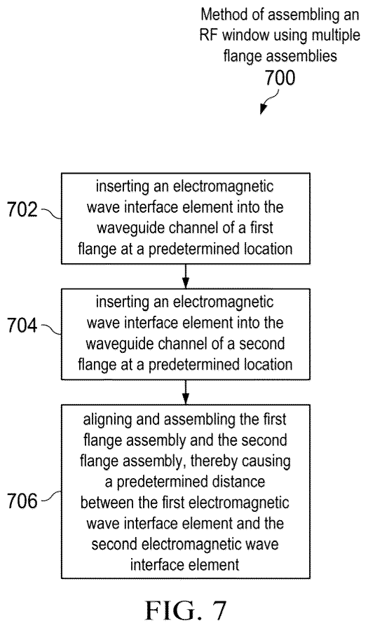

FIG. 7 is a flowchart illustrating a method 700 of assembling an RF window, e.g., RF window 118, using multiple flange assemblies, e.g., flange assemblies 104a and 104b, in accordance with some embodiments of the present invention. Method 700 begins in step 702 with a first electromagnetic wave interface element, e.g., first electromagnetic wave interface element 106a being inserted into a first waveguide channel, e.g., waveguide channel 134a, of a first flange, e.g., first flange 105a, at a first predetermined location. In some embodiments, the predetermined location may be positioned on the right side of the first waveguide channel, such that the right surface of the first electromagnetic wave interface element is flush with the right surface of the first flange. Although shown as positioned flush with the right surface of the first flange, the first electromagnetic wave interface element may be positioned at a different location, such as flush with the left surface of the first flange, at an inner position in the first waveguide channel or protruding from one of the ends.

In step 704, a second electromagnetic wave interface element, e.g., second electromagnetic wave interface element 106b is inserted into a second waveguide channel, e.g., waveguide channel 134b, of a second flange, e.g., second flange 105b, at a second predetermined location. In some embodiments, the second predetermined location may be positioned on the right side of the second waveguide channel, such that the right surface of the second electromagnetic wave interface element is flush with the right surface of the second flange. Although shown as positioned flush with the right surface of the second flange, the second electromagnetic wave interface element may be positioned at a different location, such as flush with the left surface of the second flange, at an inner position in the second waveguide channel or protruding from one of the ends. The first predetermined location need not be the same location as the second predetermined location, although they may be for ease of manufacturing.

In step 706, the first flange assembly, e.g., first flange assembly 104a, and the second flange assembly, e.g., second flange assembly 104b, are aligned and assembled, e.g., stacked, together, thereby causing a predetermined distance between the first electromagnetic wave interface element and the second electromagnetic wave interface element.

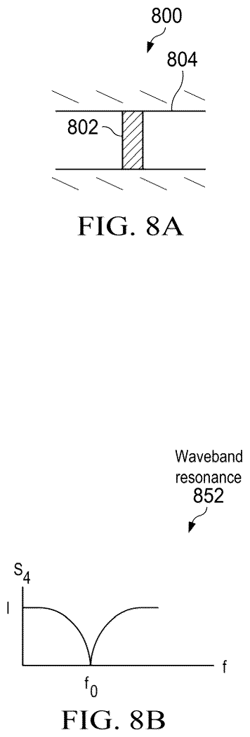

FIG. 8A is a cross-sectional side view of an electromagnetic wave interface element 802 in a waveguide 804, in accordance with some embodiments of the present invention.

FIG. 8B is a graph 852 of a reflection (S4) coefficient relative to frequency (f) for the electromagnetic wave interface element 802, in accordance with some embodiments of the present invention. As shown, the electromagnetic wave interface element 802 has a narrowband resonance at frequency f0. Frequencies with low reflection coefficient are frequencies where the RF wave is transmitted.

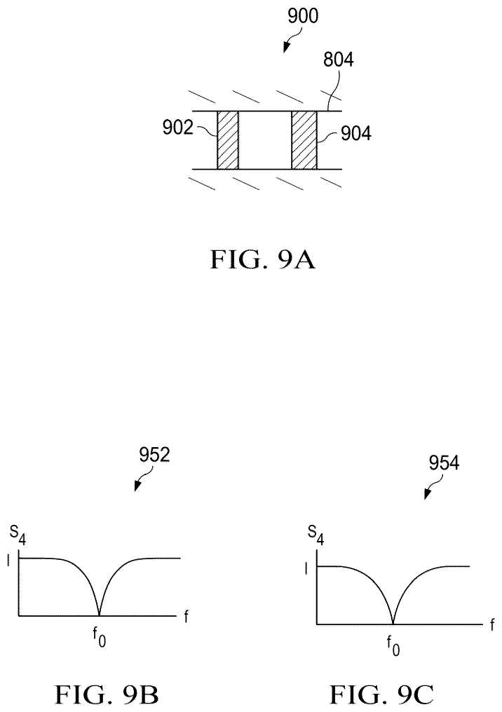

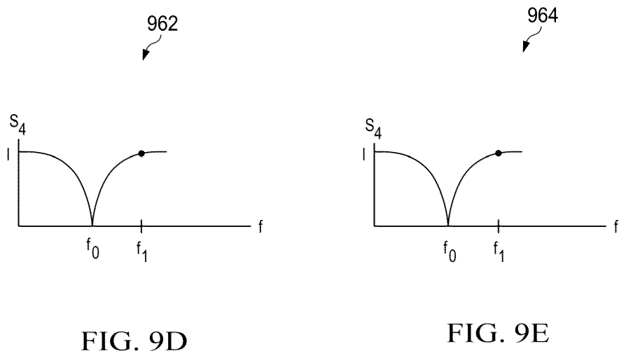

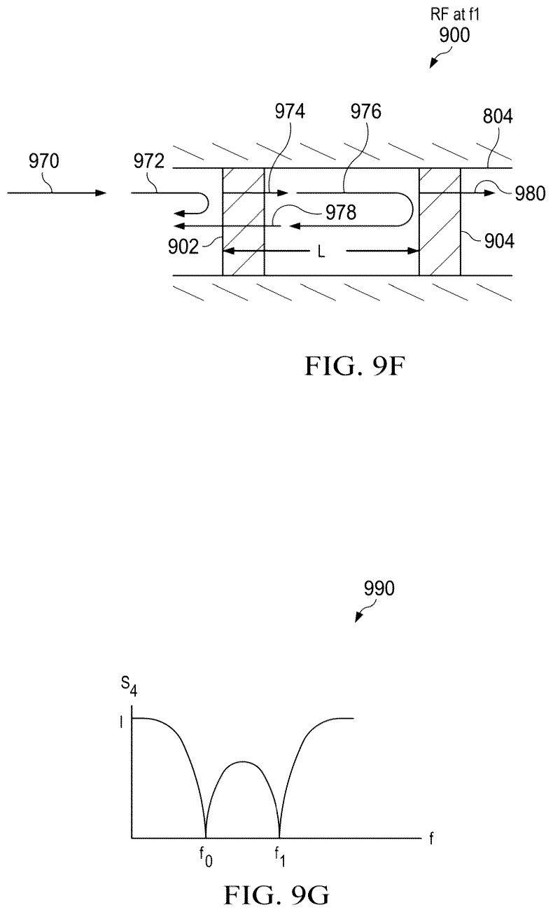

FIG. 9A is a cross-sectional side view of first and second identical electromagnetic wave interface elements 902 and 904 in the waveguide 804, in accordance with some embodiments of the present invention.

FIG. 9B is a graph 952 of a reflection coefficient relative to frequency for the first electromagnetic wave interface element 902, in accordance with some embodiments of the present invention. As shown, the first electromagnetic wave interface element 902 has a narrowband resonance at frequency f0.

FIG. 9C is a graph 954 of a reflection coefficient relative to frequency for the second electromagnetic wave interface element 904, in accordance with some embodiments of the present invention. As shown, the second electromagnetic wave interface element 904 also has a narrowband resonance at frequency f0. Around the resonant frequency, the reflection coefficient is low and the RF wave is transmitted.

Because as shown in FIGS. 9B and 9C both the first and second identical electromagnetic wave interface elements 902 and 904 have good resonance at f0, the combination will also have good resonance at frequency f0.

FIG. 9D is a graph 962 of a reflection coefficient relative to frequency for the first electromagnetic wave interface element 902, in accordance with some embodiments of the present invention. Notably, the first electromagnetic wave interface element 902 will have a large reflection at frequency f1.

FIG. 9E is a graph 964 of a reflection coefficient relative to frequency for the second electromagnetic wave interface element 904, in accordance with some embodiments of the present invention. Notably, like the first electromagnetic wave interface element 902, the second electromagnetic wave interface element 904 will also have a large reflection at frequency f1.

FIG. 9F a cross-sectional side view of the first and second identical electromagnetic wave interface elements 902 and 904 spaced apart by distance L in the waveguide 804 and further illustrating transmission and reflection paths of an electromagnetic wave at frequency f1, in accordance with some embodiments of the present invention. As shown, an electromagnetic wave 970 at frequency f1 approaches the first electromagnetic wave interface element 902. A first portion 972 reflects, and a second portion 974 transmits therethrough. The second portion 974 that transmits therethrough approaches the second electromagnetic wave interface element 904. Of the second portion 974 that transmits through the first electromagnetic wave interface element 902, a third portion 976 reflects off the second electromagnetic wave interface element 904 and a fourth portion 980 transmits therethrough. Of the third portion 976 that reflects, a fifth portion 978 transmits through the first electromagnetic wave interface element 902. The spacing L between the first electromagnetic wave interface element 902 and the second electromagnetic wave interface element 904 may be designed so that the first portion 972 that reflects from the first electromagnetic wave interface element 902 and the fifth portion 978 (the returning portion 978) that transmits through the first electromagnetic wave interface element 902 are 180 degrees out of phase and cancel each other at frequency f1. This configuration can be analyzed by taking the S-parameters of each window block individually, and doing a cascaded S-parameter analysis, with an additional straight waveguide between them for phase length.

FIG. 9G is a graph 990 of a reflection coefficient relative to frequency for the combination of the first and second electromagnetic wave interface elements 902 and 904, in accordance with some embodiments of the present invention. As shown, an RF window with the first and second identical electromagnetic wave interface elements 902 and 904 spaced apart by distance L will have two frequencies f0 and f1 with low reflection.

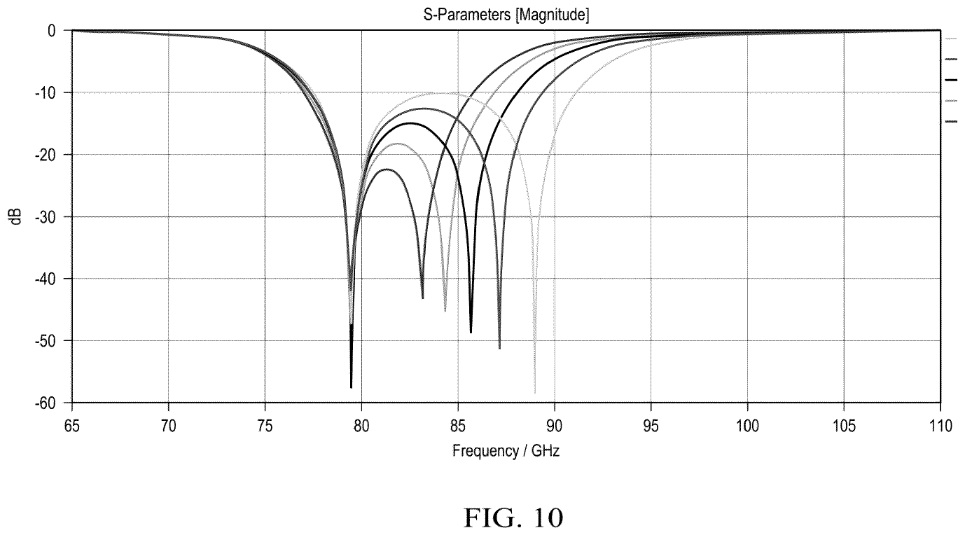

FIG. 10 is a graph of a series of reflection coefficients relative to frequency for the combination of the first and second electromagnetic wave interface elements 902 and 904 by varying the spacing L between them, in accordance with some embodiments of the present invention. As shown, as the spacing L is changed, the frequency at which the reflections changes, thereby changing the band of operating frequencies of an RF window. Although the above has been shown with two identical electromagnetic wave interface elements spaced apart by distance L, there can be more than two electromagnetic wave interface elements to further modify the band of operating frequencies. Further, the electromagnetic wave interface elements need not be identical. Still further, the waveguide need not be straight or have consistent cross-sectional shape. Other variations are also possible.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The foregoing description of the preferred embodiments of the present invention is by way of example only, and other variations and modifications of the above-described embodiments and methods are possible in light of the foregoing teaching. The embodiments described herein are not intended to be exhaustive or limiting. The present invention is limited only by the following claims.

1. A radio-frequency (RF) window, comprising:
a flange having a flange thickness and including a waveguide channel; and
a window element having dimensions based on the waveguide channel and having a window thickness based on a desired resonant operation, the window element disposed in the waveguide channel at a first location.

2. The RF window of claim 1, wherein the flange is made of metal and the window element is made of ceramic.

3. The RF window of claim 1, wherein the RF window is used to separate different environments on both sides of the RF window.

4. The RF window of claim 1, wherein the waveguide channel is a rectangular waveguide, rectangular waveguide with round corners, circular waveguide, elliptical waveguide, overmoded waveguide, ridged waveguide, or corrugated waveguide.

5. The RF window of claim 1, wherein the RF window is configured for use with a passive waveguide.

6. The RF window of claim 1, wherein the RF window is configured for use at microwave frequencies (3-30 GHz), millimeter wave frequencies (30-300 GHz), sub-THz frequencies (300 GHz-3 THz), or THz frequencies (>3 THz).

7. A radio-frequency (RF) window, comprising:
a flange including a first flange surface, a second flange surface, a flange thickness between the first flange surface and the second flange surface, and a waveguide channel; and
a first window element disposed in the waveguide channel at a first location; and
a second window element disposed in the waveguide channel at a second location, the first window element and the second window element being separated by a predetermined distance based on a desired frequency band of operations.

8. The RF window of claim 7, wherein at least one of the first and second window elements is made of ceramic.

9. The RF window of claim 7, wherein the first window element is positioned with a first window surface flush with the first flange surface.

10. The RF window of claim 9, wherein the second window element is positioned with a second window surface flush with the second flange surface.

11. The RF window of claim 7, wherein the first window element is positioned with a first window surface recessed within the waveguide channel.

12. The RF window of claim 7, wherein the first window element is disposed with a first window surface protruding from the first flange surface.

13. The RF window of claim 7, wherein the RF window is used to separate different environments on both side of the RF window.

14. A flange assembly, comprising:
a flange having a first flange surface, a second flange surface, a flange thickness between the first flange surface and the second flange surface, and a waveguide channel; and
a window element having a window thickness and disposed in the waveguide channel at a predetermined location, such that when the window element is positioned at the predetermined location the window element has a first distance to the first flange surface and a second distance to the second flange surface, at least one of the first distance or the second distance selected based on a desired frequency band of operations.

15. The flange assembly of claim 14, wherein the flange is made of metal and the window element is made of ceramic.

16. The flange assembly of claim 14, wherein the flange assembly is configured to be stacked against a second flange assembly.

17. The flange assembly of claim 14, wherein the flange assembly is configured to be stacked with a nearly identical second flange assembly.

18. The flange assembly of claim 14, wherein the first distance is zero and the second distance is not zero.

19. The flange assembly of claim 14, wherein the first distance is zero and the second distance is zero.

20. A radio-frequency (RF) window, comprising:
a first flange assembly including
a first flange having a first flange surface, a second flange surface, a first flange thickness between the first flange surface and the second flange surface, and a first waveguide channel; and
a first window element having a first window thickness and disposed in the first waveguide channel at a first location; and
a second flange assembly stacked against the first flange assembly, the second flange assembly including
a second flange having a third flange surface, a fourth flange surface, a second flange thickness between the third flange surface and the fourth flange surface, and a second waveguide channel; and
a second window element having a second window thickness and disposed in the second waveguide channel at a second location, such that when the first flange assembly is stacked against the second flange assembly the second window element has a predetermined distance to the first window element, the predetermined distance selected based on a desired frequency band of operations.

21. The RF window of claim 20, wherein the first flange assembly is nearly identical to the second flange assembly.

22. The RF window of claim 20, wherein the first flange thickness is nearly identical to the second flange thickness.

23. The RF window of claim 20, wherein the first window thickness is nearly identical to the second window thickness.

24. The RF window of claim 20, wherein each of the first window element and the second window element is made of ceramic.

25. The RF window of claim 20, wherein the first window element is positioned into a waveguide component and waveguide component is positioned in the first waveguide channel.

26. The RF window of claim 20, wherein the first window element is positioned with a first window surface flush with the first flange surface.

27. The RF window of claim 26, wherein the second window element is positioned with a second window surface flush with the second flange surface.

28. The RF window of claim 20, wherein waveguide channel space between the first window element and the second window element forms a resonant cavity, and geometry of the resonant cavity is based on a desired frequency band of operations.

29. The RF window of claim 20, wherein the RF window is used to separate different environments on both sides of the RF window.
